(19) United States
(12) Patent Application Publication
(10) Pub. No.: US 2015/0282675 A1
(43) Pub. Date: Oct. 8, 2015

(54) ANTIBACTERIAL THERMOBOX

(71) Applicant: Nedim VIDINLISAN, (US)

(72) Inventor: Nedim Vidinlisan, Balikesir (TR)

(21) Appl. No.: 14/442,852

(22) PCT Filed: Nov. 29, 2013
(86) PCT No.: PCT/TR2013/000355

§ 371 Date: May 14, 2015

(30) Foreign Application Priority Data
May 2, 2013 (TR) 2013/05180

(51) Int. Cl. A47J 47/14; B31B 7/00; B65D 81/34; B31B 1/90; B65D 81/26; B65D 81/28

(52) U.S. Cl. CPC A47J 47/145; B65D 81/264; B65D 81/28; B65D 81/34; B31B 1/90; B31B 7/00

(57) ABSTRACT

A manufacturing process of an antibacterial thermo box comprising: assembling the top of the printable outer surface layer with a layer made from polymer material comprising a plurality of moisture absorbing and heat preserving chambers having sufficient volume for applying moisture absorbing and heat preserving material, placing a moisture absorbing heat preserving materials into the chamber, coating tops of the chambers with filter paper which is air and vapor permeable, coating the box with inner surface layer corresponding to tops of the chambers, wherein a portion of the filter paper remains uncovered, and bringing to box form by folding through fold and cut lines.

### TECHNICAL FIELD

The disclosure is related to a box manufacturing process and an antibacterial thermo box manufactured as a result of this manufacturing process that enables cooked hot transportable foods such as pizza, pita, lahmacun and hamburger having antibacterial properties to be delivered to the consumer via delivery service.

### BACKGROUND

Nowadays foldable boxes are used to deliver cooked hot transportable foods such as pizza, pita, lahmacun and hamburger to consumers via delivery service. Cooked hot foods, after being put into packing boxes, should be rapidly delivered to the consumer and the consumer should rapidly consume the food. With available packing and storage boxes, when cooked hot transportable foods such as pizza, pita, lahmacun and hamburger cannot be delivered to the consumer in a short time, they lose their freshness and get wet, thus the consumer has to eat the delivered food in a wet state after they lose their warmth and freshness. This situation causes the consumers that use the delivery service to have doubts about using the delivery service.

In order to solve such problems, the companies make a commitment that pre-cooked hot transportable foods will be delivered in a short time, and when they cannot fulfill their commitment, the ordered goods are given to the consumer for free. In order not to encounter such situations and be able to deliver the cooked hot transportable foods to the consumer in the promised time, the companies have to employ many personnel, quick movable vehicles such as motorcycles which are allocated for these personnels' use and very serious computer controlled tracking systems which are established to prevent faults that may be encountered during work. If these companies cannot provide the ordered goods to the consumer in the promised time in a hot, not-wetted and fresh state, they lose their reliability and preferability and they cannot achieve the commercially desired success.

In such cases, the consumer goes to places such as restaurants and diners that produce these foods instead of ordering from delivery service and tries to meet their needs directly in such places.

However such places can usually not serve many people simultaneously. Moreover, working people do not want to leave their work for a long time. In such places there are not suitable spaces for consumers to park their cars.

### SUMMARY

Nowadays, a delivery service not only meets the needs of the workplace environment, but also of the people who host guests in their homes. Since, likewise, people want to serve the cooked hot transportable foods to their invited or uninvited guests in a hot and fresh state, they want the ordered food to be delivered in the shortest time possible.

The success of the companies that provide delivery service depends on serving the cooked hot transportable foods to the consumer in a hot, not-wetted, fresh state.

Furthermore, the consumer that orders the delivery should consume the delivered cooked hot transportable foods via available boxes in a short time. In the case the ordered good has to wait, the food loses its freshness, warmth, and taste, and may degrade due to harmful organisms that may form on the food that are dangerous for human health.

The boxes that are used in the current state of the art are produced from foldable cardboard. However, this cardboard should be stored in hygienic environments before being transformed into box form. During the manufacturing of such boxes, due to the hygiene and outside contact of the people who prepare the box, the hygienic property of the cooked hot transportable food is lost, and the consumer doubts using the delivery service. When all food products including the cooked hot transportable foods are served in unhygienic environments, they endanger human health.

In delivery service, when the cardboard boxes used in the current state of the art are used, since the vapor inside the box penetrates into the cooked good in a short time, it causes the ordered food to get spoiled. In order to prevent the foods in such boxes from getting spoiled, ventilation holes are opened to the sides and topside of the delivery boxes and the hot vapor is removed from these openings. However, removal of hot vapor caused by cooked hot transportable foods from ventilation holes causes the foods to lose their warmth and freshness. Since cooked hot transportable foods have direct contact with air, the spoilage may occur in a shorter time. Particularly, wetting of the cooked hot transportable foods due to condensation of the hot vapor may cause many harmful microorganisms to grow on the food product. Such harmful microorganisms that grow on the cooked hot transportable food cause the food delivered via delivery service to lose its properties and get spoiled in a short time.

When no ventilation holes are opened onto the packing boxes, the moisture formed by the hot vapor and the condensation due to cooling causes the cooked hot transportable foods to get wet. In such a case it is not preferred by the consumer.

An aspect of the antibacterial thermo box is; to maintain the warmth of the cooked hot transportable foods such as pizza, pita, hamburger and lahmacun in the box during their delivery to the consumer via delivery service and to extend the freshness period of the food product. With our antibacterial thermo box, by eliminating the wetting that forms during condensation of the hot vapor present in the cooked hot transportable foods such as pizza, pita, hamburger and lahmacun, the cooked food product is prevented from getting wet while being covered and thus from getting spoiled.

In order to solve the abovementioned technical problems which are experienced with the boxes that are used in the current state of the art, slots that can absorb the hot vapor formed by the cooked hot transportable foods such as pizza, pita, hamburger and lahmacun are formed inside our antibacterial thermo box. Thus, there remains no need for opening ventilation holes around or on top of the box in order to prevent the hot vapor in the box from wetting the food by condensing on the cooked food product. The heat of the hot vapor which is present on the cooked hot transportable foods such as pizza, pita, hamburger and lahmacun inside our antibacterial thermo box stays in the box and the heat is locked inside the box. In this way, the maintenance time of the heat inside the box is increased. Thus, while on one hand the heat is maintained inside the box, on the other hand the outside contact of the box is prevented, the microbes and harmful organisms that may enter into the box from outside are blocked. The cooked hot transportable foods such as pizza, pita, hamburger and lahmacun that are ordered for delivery stay in the box for a longer time and hygiene is obtained.

In our box, in order to keep the heat of the foods inside the box, polyurethane, heat isolating materials are used between two layers, insulation is performed by reducing the heat transfer between inside and outside of the box, ventilation holes are not needed anymore as in the current available boxes.

Due to delivery of the cooked hot transportable foods such as pizza, pita, hamburger and lahmacun to the consumer by preserving its warmth and freshness without getting spoiled, it is enabled that especially the companies that serve through delivery service can get more orders, much many orders can be delivered to the consumers with much less personnel.

Moreover, after receiving the order, since the consumer who ordered the delivery does not have to eat the cooked hot transportable foods such as pizza, pita, hamburger and lahmacun in a short time, he/she does not have to act quickly.

The aspects of our antibacterial thermo box that especially enables the cooked hot transportable foods such as pizza, pita, hamburger and lahmacun to be served and delivered to the consumer via delivery service, and that enables both the company providing the delivery service and the consumer who orders the delivery to save time can be given as below:

To protect cooked pastry against bacteria, viruses and harmful microorganisms coming from outside

To prevent the cooked pastry from getting doughy and getting spoiled by preventing moisture formation inside the box

To extend the preservation and transportation time of the product inside the box by extending the cooling time

To decrease the transportation cost of the cooked pastry good to the consumer via delivery service

To obtain an environmentally harmless product by employing methods that are used in recycling of polymer based materials and by manufacturing a recyclable box.

### BRIEF DESCRIPTION OF THE DRAWINGS

The description of the figures that aid in providing a better understanding about the box are given below:

FIG. 1: Detail view of the open state of our packing box;

FIG. 2: A side (A-A) cross-sectional view of our packing box;

FIG. 3: Detail of the side (A-A) cross-sectional view of our packing box; and

FIG. 4: A partially open perspective view of our packing box.

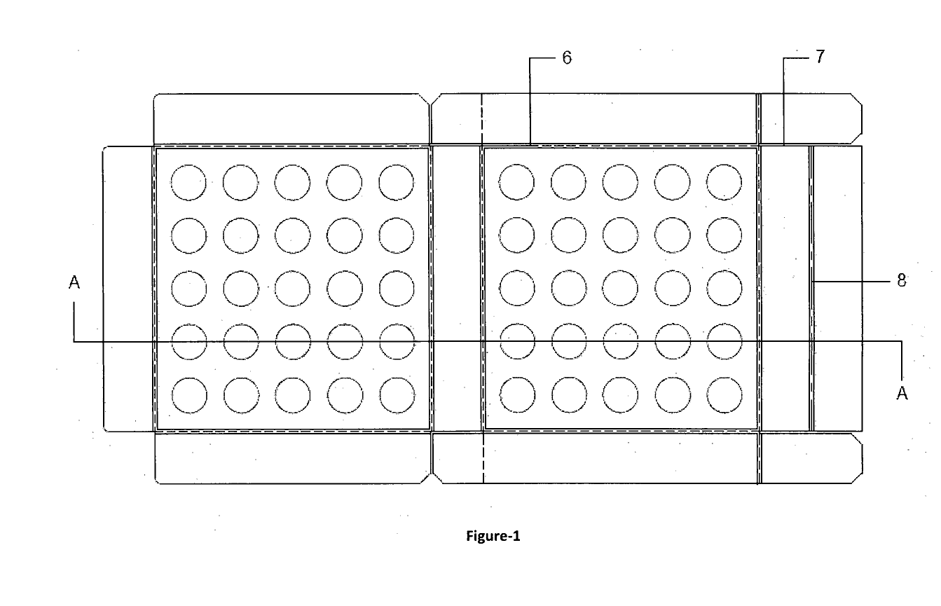

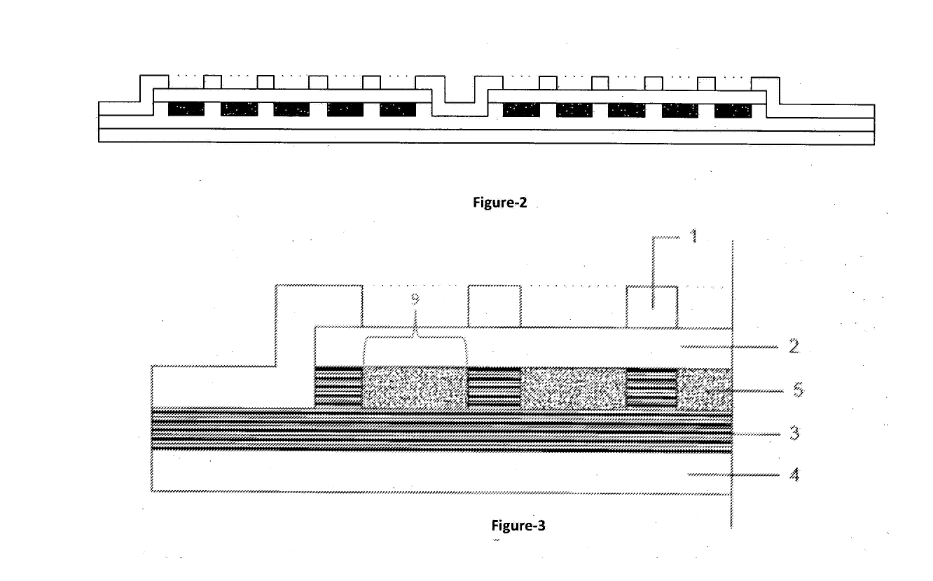

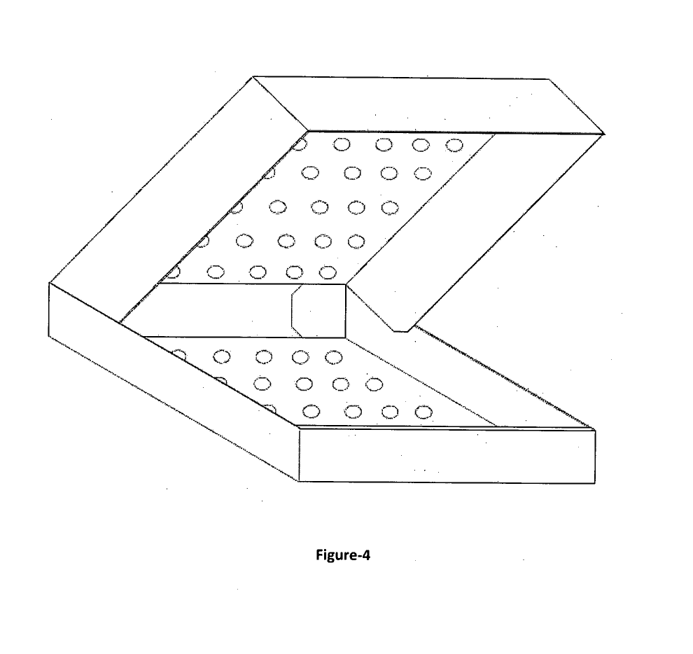

### BRIEF DEFINITIONS OF THE PART NUMBERS MENTIONED IN THE FIGURES THAT AID IN UNDERSTANDING OF OUR PACKING BOX ARE GIVEN BELOW

1. Box inner surface coating layer
2. arid vapor permeable layer
3. Layer formed from polymer material
4. Printable outer surface layer
5. Moisture absorbing material
6. 90 degrees coating line
7. Cutting lines
8. 180 degrees folding line
9. Moisture absorbing and heat preserving cha

### DETAILED DESCRIPTION

Our antibacterial thermo box is related to a process of shaping a polymer (3) having a moisture absorbing and heat preserving chamber (9) formed therein to a box form by coating bottom and top surfaces with coating products suitable for manufacturing process and is related to the antibacterial thermo box manufactured as a result of the said process.

In our antibacterial thermo box; many moisture absorbing and heat preserving chambers (9) are formed which are formed by first being combined on the printable outer surface layer (4) with the layer formed from polymer material (3) and then by placing moisture absorbing materials (5) onto the layer (3) formed from mentioned polymer material. Thus, strength is provided to our antibacterial thermo box and the heat absorbed by the material is prevented from escaping. If it was directly made on the printable paper, the heat absorbed from inside the box would escape and the food product is enabled to stay hot for a longer time and the cooling rate is decreased.

The moisture absorbing material (5) present in these chambers (9) prevents the condensation caused by the cooling from penetrating into the food by absorbing the hot vapor of the cooked hot transportable foods such as pizza, pita, hamburger and lahmacun which are placed inside the box and which are completely isolated from outside. Thus the vapor present in the box is absorbed and the warmth of the foods can be preserved inside the box. The moisture absorbing and heat preserving chamber (9) inside the box preserves the absorbed moisture and vapor in itself, the moisture and vapor stays in this chamber (9).

The top of the moisture absorbing and heat preserving chamber (9) filled with moisture absorbing material (5) is coated with a filter paper which is an air and vapor permeable special layer (2). The reason why top of the chamber (9) is coated with filter paper is to prevent contact of moisture absorbing material (5) in powder form with the cooked food product inside the box. The filter paper used here is the paper used in tea bags. The upper surface of the filter paper is coated with the box inner surface coating layer (1). On top of the surface where cooked hot transportable foods such as pizza, pita, hamburger and lahmacun is placed, a coating-layer-deep space is formed on the position directly above the moisture absorbing and heat preserving chamber (9).

After the inner surface coating is finished, the surface this layer that contacts the food is coated with a nanotechnologic antibacterial product that is safe for human health. Thus, the harmful bacteria and microbes that may form in the box due to contact with air are killed.

Our antibacterial thermo box may be formed by performing this operation to only the bottom surface on which the food is places or by performing this operation to both the top and bottom surfaces or only to top surface.

Moreover, due to the properties of our antibacterial thermo box, the box may be subjected to pre-heating up to 50-60 C degrees before the hot food is placed in it. Thus, the warmth of the product placed into the box can be preserved longer compared to current known boxes. Since in its precedents heating of the box is not possible, when the cooked product is placed into the box, it wastes some of its own heat in order to warm up the box and it loses its heat until the temperature of both the product and the box becomes equal.

In our antibacterial thermo box, clinoptilolite form of Zeolite is used inside the moisture absorbing and heat preserving chamber (9). The feature of using this material is that its heat retention capacity and moisture absorbing properties are much higher than other materials.

1. A manufacturing process of an antibacterial thermo box which enables delivery of cooked hot transportable foods comprising;
assembling a top of a printable outer surface layer made from polymer material comprising a plurality of moisture absorbing and heat preserving chambers having sufficient volume for applying a moisture absorbing and heat preserving material,
placing a moisture absorbing and heat preserving material into the plurality of moisture absorbing and heat preserving chambers,
coating tops of the plurality of moisture absorbing and heat preserving chamber with filter paper in order to prevent contact between the moisture absorbing and heat preserving material and food placed into the box, wherein the filter paper comprises an air and vapor permeable layer,
coating the box with an inner surface layer for establishing a layer-deep space on positions corresponding to tops of the moisture absorbing and heat preserving chambers, wherein the filter paper covering tops of the plurality of moisture absorbing and heat preserving chambers remains uncovered, and
bringing the printable outer surface layer to box form by folding through fold and cut lines.

2. The manufacturing process of the antibacterial thermo box according to claim 1 further comprising spraying the inner surface of the box is made to be with an antibacterial by spraying silvery zeolite.

3. The manufacturing process of the antibacterial thermo box according to claim 1 wherein a clinoptilolite zeolite is placed inside the plurality of moisture absorbing and heat preserving chambers.

4. The antibacterial thermo box manufactured according to process described in claim 1 comprising the printable outer surface layer comprising a layer made from a polymer material which has the plurality of moisture absorbing and heat preserving chambers and which prevents heat in the box from escaping, the filter paper comprising an air and vapor permeable layer, the inner surface layer on positions corresponding to tops of the moisture absorbing and heat preserving chambers, 90 degree fold lines and cutting line, and 180 degrees fold lines and cutting lines.

5. The antibacterial thermo box according to claim 4 wherein a clinoptilolite zeolite is present inside the moisture absorbing and heat preserving chamber as the moisture absorbing and heat preserving material.

6. The antibacterial thermo box according to claim 5 comprising the sprayed silvery zeolite coating the inner surface of the box.

7. The manufacturing process of the antibacterial thermo box according to claim 2 wherein a clinoptilolite zeolite is placed inside the plurality of moisture absorbing and heat preserving chambers.

8. The antibacterial thermo box manufactured according to process described in claim 7 comprising the printable outer surface layer comprising a layer made from a polymer material which has the plurality of moisture absorbing and heat preserving chambers and which prevents heat in the box from escaping, the filter paper comprising an air and vapor permeable layer, the inner surface layer on positions corresponding to tops of the moisture absorbing and heat preserving chambers, 90 degree fold lines and cutting line, and 180 degrees fold lines and cutting lines.

9. The antibacterial thermo box according to claim 8 comprising the sprayed silvery zeolite coating the inner surface of the box.

10. The antibacterial thermo box manufactured according to the process described in claim 2 comprising the printable outer surface layer comprising a layer made from a polymer material which has the plurality of moisture absorbing and heat preserving chambers and which prevents heat in the box from escaping, the filter paper comprising an air and vapor permeable layer, the inner surface layer on positions corresponding to tops of the moisture absorbing and heat preserving chambers, 90 degree fold lines and cutting line, and 180 degrees fold lines and cutting lines.

11. The antibacterial thermo box according to claim 10 wherein a clinoptilolite zeolite is present inside the moisture absorbing and heat preserving chamber as the moisture absorbing and heat preserving material.

12. The antibacterial thermo box according to claim 11 comprising the sprayed silvery zeolite coating the inner surface of the box.

13. The antibacterial thermo box according to claim 10 comprising the sprayed silvery zeolite coating the inner surface of the box.

14. The antibacterial thermo box manufactured according to the process described in claim 3 comprising the printable outer surface layer comprising a layer made from a polymer material which has the plurality of moisture absorbing and heat preserving chambers and which prevents heat in the box from escaping, the filter paper comprising an air and vapor permeable layer, the inner surface layer on positions corresponding to tops of the moisture absorbing and heat preserving chambers, 90 degree fold lines and cutting line, and 180 degrees fold lines and cutting lines.

15. The antibacterial thermo box according to claim 14 comprising the sprayed silvery zeolite coating the inner surface of the box.

16. The antibacterial thermo box according to claim 4 comprising the sprayed silvery zeolite coating the inner surface of the box.
